(19) United States
(12) Patent Application Publication
(10) Pub. No.: US 2005/0139109 A1
(43) Pub. Date: Jun. 30, 2005

(54) Changing station for printing press sleeves

(76) Inventors: Franz Plasswich, Bremen (DE); Robert Blom, Tecklenburg (DE)

Correspondence Address: JACOBSON HOLMAN PLLC, 400 SEVENTH STREET N.W., SUITE 600, WASHINGTON, DC, 20004, US

(21) Appl. No.: 10/506,686

(22) PCT Filed: May 9, 2003
(86) PCT No.: PCT/EP03/04950

(30) Foreign Application Priority Data
May 25, 2002 (DE) 102 23 414.0

(51) Int. Cl. B41F 27/12

(52) U.S. Cl. 101/477

(57) ABSTRACT

Changing station for sleeves (12, 15) of a printing machine (1), with a magazine (17) with at least one take-up device (18) for sleeves (12, 15), which (8) is vertically conveyable, whereby an additional conveyance option (21) is provided for the magazine (17) in the horizontal direction, which ensures that the magazine (17) is conveyable on a horizontal (x) and on a vertical (y) plane alongside the printing machine (1).

The invention concerns a changing station for sleeves of printing machines.

It is often necessary to change the print impression subjects on the printing rollers in order to implement print job orders. In order to be able to carry out a job order change as quickly and simply as possible, only the so-called printing sleeves that carry the subjects of the print impression are changed.

The as yet unpublished patent application DE 101 12 522 shows a take-up device with a plurality of carrier bars for receiving printing sleeves. This take-up device is set up in the proximity of a printing group. For this purpose, it possesses wheels, by which it is movable over the floors of the machine hall. Also, in order to set up the take-up device at an appropriate distance away from the more highly situated printing groups, the take-up device can be positioned on a lifting platform positioned alongside the printing machine. Removed sleeves are manually pulled off from the printing roller and/or from the anilox roller by the operating personnel, are lifted over to the take-up device and are slid onto a carrier bar of the take-up device. As a rule, the take-up device also carries the sleeves for the new print job order, which are also manually moved and pulled on to the printing roller and/or the anilox roller. In the case of the described operations, the operating personnel stands on the aforementioned lifting platform and lifts the sleeves to be changed from the printing machine to the take-up device and vice versa.

This work obviously made hard by the weight of the sleeves and the necessity of pulling up the bar to be changed up to the printing cylinder or up to the carrier bar is often rendered even more difficult when the position of the sleeve to be changed in the take-up device is greatly offset in terms of the axis of the printing roller or of the anilox roller.

The task of the current invention consists in facilitating this operation.

The task is resolved by the characteristic features of claim 1. In this case, a magazine in accordance with the invention can also simply comprise a take-up device. A take-up device can comprise a carrier bar but also of a shelf-like or drawer-shaped repository or of other types of structural elements suitable for the storage of sleeves.

The horizontal displacement capability of the magazine can be advantageously achieved by one or several crane-like devices, whereby steering of the magazine from several crane cables introduces the possibility of tipping over the magazine. Advantage can be taken from this possibility when several take-up devices of the magazine are to be simultaneously aligned with several rollers. If the axes of these rollers do not lie on one horizontal plane, the possibility of tipping over the magazine can be very useful. Of course, to realize this possibility, devices other than the setup of several cranes also come under consideration.

The horizontal displacement capability can advantageously be secured by the aid of linear guidance. When combining the devices mentioned above to realize the capability of displacement, it is recommended to use the crane and track system presented in the description of the invention.

In the case of magazines with several take-up devices, supplementary means are useful to change the position of at least one take-up device inside of the magazine. With the aid thereof, a “fine adjustment” of the position of the take-up device can be made relative to the axis of a roller without requiring that the entire magazine be moved. In the claims and in the description of the invention subject matter, various possibilities for realizing this fine adjustment are disclosed. First, a revolving magazine based on a disc is claimed, said revolving magazine rotating the take-up devices around a rotational center. A similar underlying principle consists in an endless belt or in a chain belt that runs circularly in the magazine and hereby leads the take-up devices on with itself. Also, devices that are based on a shaft-like or shelf-like organization system and that remind us in their function of the conventional cigarette machines can be advantageously applied in the framework depicted.

Of all the means for changing the position of at least one of the take-up devices in the magazine, it is a great advantage if at least two take-up devices can be set up in the same position, one behind the other. If this possibility exists, an empty take-up device can first be brought into a favorable position relative to a roller axis for the purpose of exchanging the sleeves. This take-up device can then be loaded with the sleeve used in the preceding printing process and then be brought into another position. The very take-up device carrying the “new” sleeve to be applied in the printing machine will then assume the favorable position relative to the roller axis.

Another advantageous characteristic lies in the spacing distance that separates the take-up devices from one another. If, for example, the anilox roller sleeve as well as the printing roller sleeve of an inking unit must be changed simultaneously to save time, then the spacing of the take-up device assigned to the two rollers should correspond to the mutual spacing between the rollers so that the position favorable for changing the two rollers can be “simultaneously” attained. No subsequent additional adjustment of the magazine or of the take-up devices in the magazine is then required.

As initially stated, the changing operation to be performed by the operating personnel will be facilitated by any improvement in the alignment of the take-up devices relative to the anilox or printing rollers. When the alignment of the take-up devices is especially good, the sleeve can be directly moved over from the roller onto the take-up device, whereby the sleeve is always carried together either by the take-up device, the roller or by both of the two structural elements. To this end, it is necessary that the spacing between the free end of the take-up device and the free end of the roller or of its shaft be smaller than the axial length of the sleeve.

To facilitate the realization of this form of embodiment, drawer-like slide-in units [inserts] can also be provided to extend the loading surface of the take-up devices. When changing the sleeves, these slide-in units can extend the take-up device in the direction of the free end of the rollers and, in this manner, they can carry the sleeve during sleeve change so that the operating personnel has less burdensome work to do. When applying carrier bars as take-up devices, these slide-in units, as a rule, comprise tubes that can be pulled out of the carrier bars when needed. This special form of embodiment is also more specifically detailed in the description of the subject matter.

In particular, with the use of carrier bars as take-up devices, it is advantageous if the axis of the printing roller is indeed actually in alignment with the axis of the associated carrier bar. Then the spacing distance between the end of the carrier bar and the free end of the associated roller can be extremely reduced during the changing operation. The sleeve then only needs to be pulled over from the roller onto the bar or from the bar on to the roller.

The individual figures show:

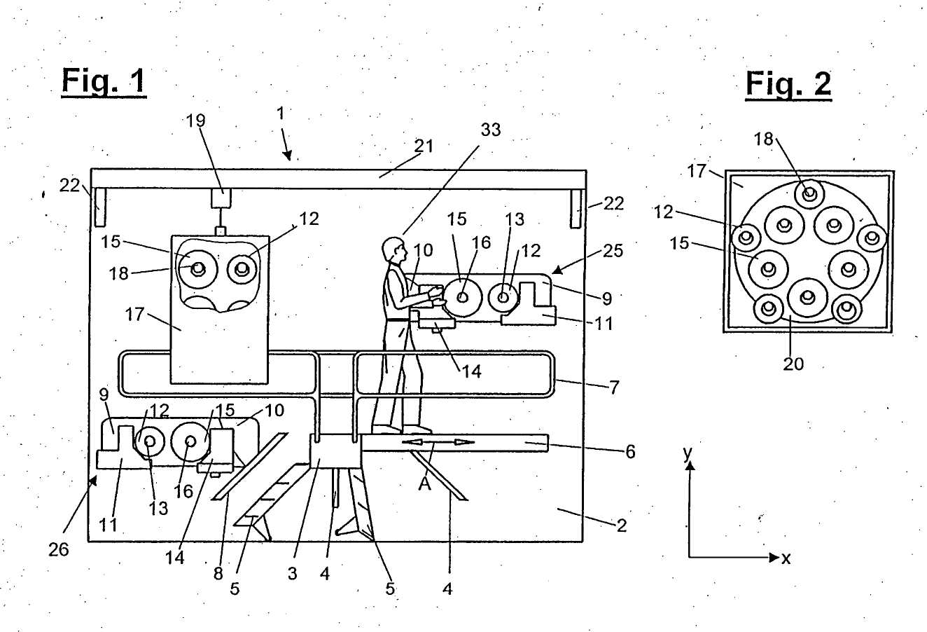

FIG. 1 A side view of a printing machine

FIG. 2 A view of the open side of a magazine for sleeves

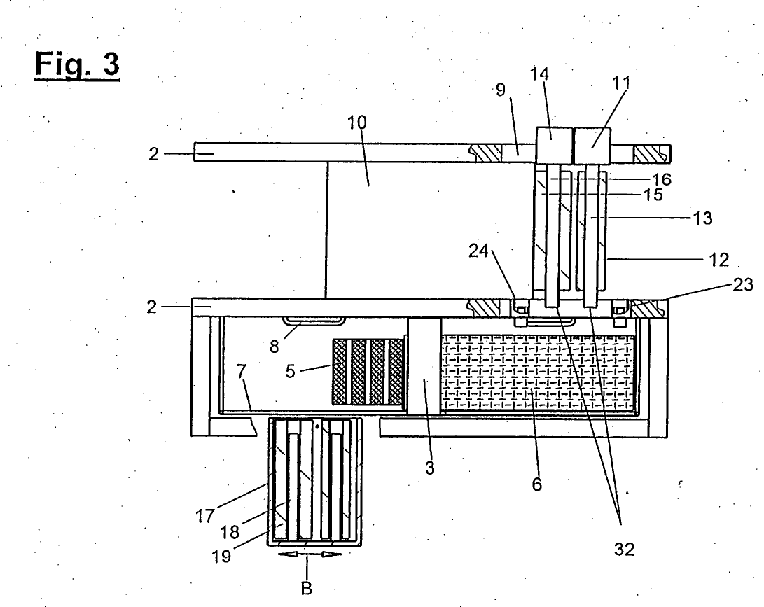

FIG. 3 A top view of the printing machine from FIG. 1

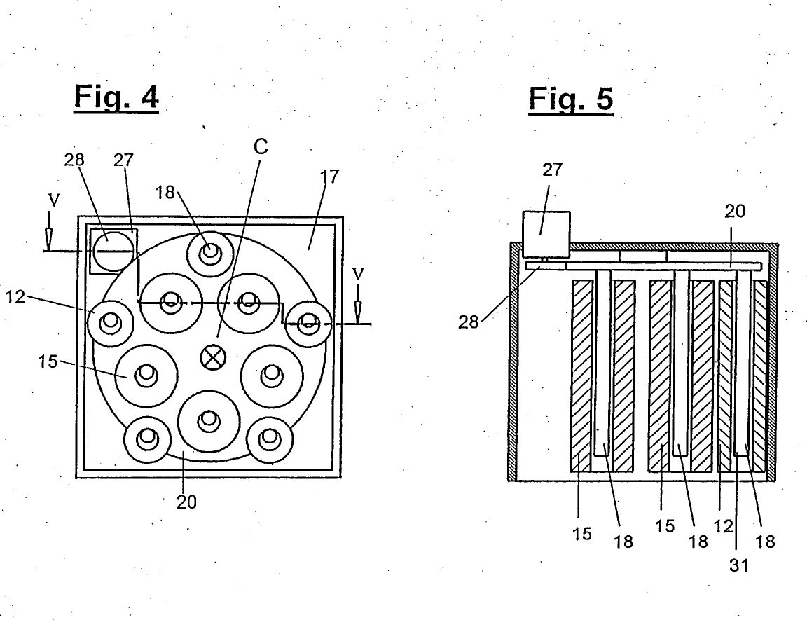

FIG. 4 A view of the open side of a magazine for sleeves

FIG. 5 A section through the magazine represented in FIG. 4

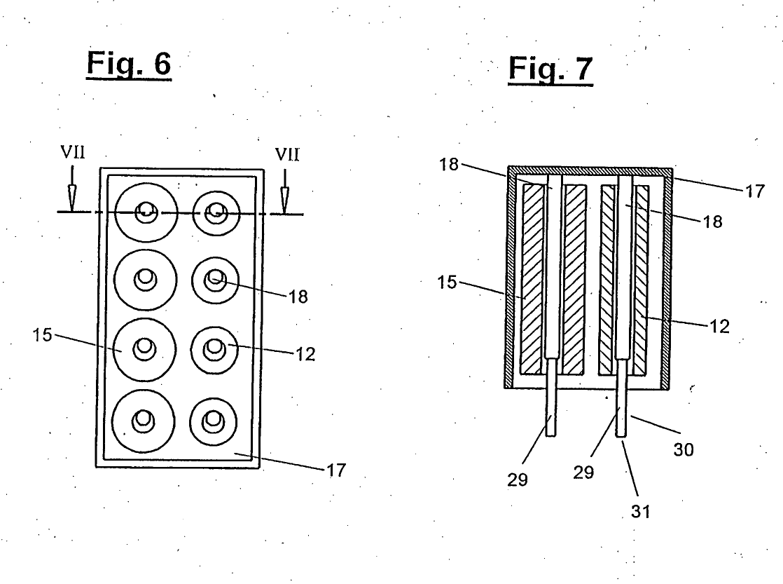

FIG. 6 A view of the open side of another magazine for sleeves

FIG. 7 A section through the magazine represented in FIG. 6

FIG. 1 shows a printing machine 1 in which two inking units 25, 26 are represented that are made visible by the cutouts 9 in the side stand 2. Essential component parts of an inking unit are the anilox roller 13 and the printing roller 16, which are respectively supported on the bearing block for anilox rollers 11 or on the bearing block for printing rollers 14 over an underprop bearing 23, 24. Through the lower cutout 9, a section of the counter-pressure cylinder 10 can also be seen.

When changing an anilox roller sleeve 12 or a printing roller sleeve 15 in the upper area of the printing machine 1, the checker plate for footboard 6 is first pulled out by hand in the direction of arrow A so as to be subsequently positioned beneath the printing group to be accessed. For this purpose, the footboard 6 is slidably supported in the platform 3. For reasons of stability, the platform 3 is additionally supported by a support 4 on the side stand 2. On the side opposite where the footboard 6 is positioned, steps 5 fold out. The operating personnel can now access one of the upper inking units 25 via the steps 5 and the footboard 6. In order to facilitate the climb, step railings 8 are secured on the side stand 2. Falling from the footboard 6 is prevented by a side railing 7.

If the inking unit to be accessed is located in the lower area of the printing machine, then the footboard 6 and the steps 5 will create an obstruction. The footboard 6 can be moved to the side respectively opposite the counter-pressure cylinder and the steps 5 can be folded in their vertical resting position. The printing group is now openly accessible.

The steps necessary to carry out the sleeve change procedure are easy to recognize in FIG. 3. After opening the front face underprop bearings 23, 24, the bearing blocks 11, 14 can be slid to the side so that the printing roller sleeve 15 and/or the anilox roller sleeve 12, which are slipped on to the printing roller 16 or on to the anilox roller 13 can be accessed. The sleeves 15, 12 can now be removed by hand from the rollers 13, 16.

For transporting away the sleeves 12, 15, a magazine with carrier bars 18 for sleeves 17, which magazine can be equipped with casters for conveyance, which are not represented here, is lifted by the aid of a crane 19. This crane 19 essentially comprises of a winding drum and of a motor. On a sliding carriage, the crane 19 is movable along the runway rail 21 running parallel to the side stand, whereby the displacement of the take-up devices 18 is ensured in the horizontal direction (x). In the shown exemplary embodiment, the shelf 17, which is closed on three sides and open on one side, is secured to the crane in such a manner that the carrier bars 18 run parallel to the rollers 13, 16 and the open side of the magazine 17 faces the printing machine 1, as is represented in FIG. 3. As mentioned, the hoist 19 gliding along the runway rail 21 and, together with it, the magazine 17 are movable in the direction of the double arrow, in horizontal direction (x) parallel to the side stand 2. With a favorable positioning of the magazine 17, the operating personnel 33 only need move the sleeves 12, 15 over extremely short distances.

In order to do away with repositioning the entire magazine 17 when new sleeves 12,15 are to be slipped on to the printing rollers 16 or on to the anilox rollers 13 during one same work operation, the shelf 17 can be equipped with carrier bars 18 exhibiting the same spacing distance as the axes of the two cylinders 13, 16 when in the mutually removed state.

FIGS. 6 and 7 show the exemplary embodiment of the magazine 17 in a detailed version. This exemplary embodiment is also shown in FIGS. 1 and 3.

This magazine 17 comprises a case 32 that is only open on the one side, in which the carrier bars 18 are aligned in rows, in a matrix formation, to receive the sleeves 12, 15. The spacing distance between the two carrier bars 18 on a (horizontal) line corresponds to the spacing distance between the axes of the inking rollers 16 and printing rollers 13 of an inking unit 25, 26.

When changing the sleeves, the entire magazine is positioned by the aid of a crane 19 and of the rails 21 in such a manner that the axes of the above-mentioned rollers 13, 16 of an inking unit 25, 26 are aligned on one plane with the associated empty carrier bars 18. The sleeves are slipped over onto the carrier bars. After this, the vertical position of the entire magazine is changed with the crane so that the two carrier bars with the new sleeves 12, 15 to be installed into the inking unit are aligned with the axes of the two aforementioned rollers. After this, the rollers are fitted with these sleeves. FIG. 6 shows a section that clarifies the function of the inserts 29. These have been specifically conceived for carrying the sleeves during the sleeve changing operation. During sleeve change when the insert 29 is extended out, the free end 31 of the sleeve take-up device 18 is moved in the direction of the free end 13 [sic; 31?] of the rollers 16,13 or of their shafts.

FIGS. 2, 4 and 5 show another magazine 17 that can be applied in a sleeve changing device in accordance with the invention.

This magazine contains means by which the position of the take-up devices in the magazine 17 can be changed—said take-up devices here also being carrier bars 18. These means essentially comprise a rotating disc 20, onto which carrier bars are affixed, as is represented in FIG. 2. The rotational axis A of the disc runs parallel to the direction of the carriers bars 18. In this manner, by rotating the disc 20, it is possible to preposition the selected sleeves 12,15 into the favorable position for sliding onto the rollers. Also arranged on this disc is respectively one bar 18 carrying an anilox roller sleeve and respectively one bar carrying a printing roller sleeve, spaced apart in such a manner, that both of the aforementioned carrier bars can be simultaneously brought into a position of alignment together with the two rollers 13, 16 of an inking unit. The advantage of such a type of magazine construction as compared to the type of construction shown in FIGS. 6 and 7 consists therein that during the changing of sleeves, no alteration of the position of the entire magazine 17 is required relative to the printing machine 1, which would bring the carrier bars charged with the sleeves of the executed job order out of aligned position with the rollers. This process is effected by a simple rotation of the disc, which is carried out by the motor 27 and by the torque transfer cylinder 28. At the end of the rotation of the cylinder, the carrier bars with the “new” sleeves 15, 12 align with the axes of the rollers 17, 16.

Reference number list

| | |
|---|---|
| 1 | Printing machine |
| 2 | Side stand [frame] |
| 3 | Platform |
| 4 | Support |
| 5 | Steps |
| 6 | Footboard |
| 7 | Safety railing |
| 8 | Step railing |
| 9 | Cutout in side stand |
| 10 | Counter-pressure cylinder |
| 11 | Bearing block for anilox roller |
| 12 | Anilox roller sleeve |
| 13 | Anilox roller |
| 14 | Bearing block for printing roller |
| 15 | Printing roller sleeve |
| 16 | Printing roller |
| 17 | Magazine for sleeves |
| 18 | Carrier bar |
| 19 | Hoist |
| 20 | Rotatable disc |
| 21 | Runway rail |
| 22 | Elbow |
| 23 | Underprop bearing for anilox roller |
| 24 | Underprop bearing for printing roller |
| 25 | Inking unit |
| 26 | Inking unit |
| 27 | Motor for rotating the disc 20 |
| 28 | Cylinder for transfer of torque |
| 29 | Insert for extending loading surface of the take-up device |
| 30 | Free end of the rollers or of their shafts |
| 31 | Free end of the inserts 29 |
| 32 | Case |
| 33 | Operating personnel |
| C | Rotational axis of the disc |

1. Changing station for sleeves (12, 15) of a printing machine (1), with a magazine (17) with at least one take up device (18) for sleeves (12, 15), which (8) is vertically conveyable, thus characterized that an additional conveyance option (21) is provided for the magazine (17) in the horizontal direction, which ensures that the magazine (17) is conveyable on a horizontal (x) and on a vertical (y) plane alongside the printing machine (1).

2. Changing station in accordance with claim 1, thus characterized that the vertical conveyability of the magazine (17) is ensured by at least one crane (19).

3. Changing station in accordance with claim 1, thus characterized that the horizontal conveyability of the magazine (17) is ensured by linear guidance such as by a rail.

4. Changing station in accordance with claim 1 characterized by means (20) for changing the position of at least one take-up device (18) inside of the magazine (17).

5. Changing station in accordance with claim 4 thus characterized that the means (20) for changing the position of at least one take-up device (18) comprise an endless circulating transport means, such as a disc (18), a chain or a belt, which circulates around inside of the magazine (17) and against which at least the one take-up device (18) is supported.

6. Changing station in accordance with claim 4 thus characterized that the means (20) for changing the position of at least one take-up device (18) comprise a shelf or shaft system, in which at least one carriage is movable, from which at least the one take-up device (18) is suspended.

7. Changing station in accordance with claim 4 one of the claims 4 through 6 thus characterized that a plurality of take-up devices is provided in the magazine (17), of which at least two can sequentially assume the same position.

8. Changing station in accordance with claim 1 thus characterized that at least two take-up devices (18) in the magazine (17) have the same spacing distance from one another as the axes of the printing roller sleeves and of the anilox roller sleeves during the fitting process.

9. Changing station in accordance with claim 1 thus characterized that the spacing distance between the free end (31) of the take-up device and the free end of the shaft of the printing roller or of the anilox roller during removal or fitting of the sleeve (12, 15) is smaller than the length of the sleeve in its axial direction.

10. Changing station in accordance with claim 1 thus characterized that at least one take-up device comprises drawer-like inserts (29) that can be drawn out of the take-up device and that extend the loading surface of the take-up device (17) in the direction of the free end of the rollers.

11. Process for changing the sleeves of a printing machine (1), whereby the sleeves of the take-up device (17) changed during refitting of the printing machine are guided to the take-up or removed from the take-up, which is vertically conveyable thus characterized that the horizontal position of at least the one take-up device (18) is also adjusted, whereby at least the one take-up device is conveyed on a horizontal (x) and on a vertical (y) plane alongside the printing machine (1).

12. Process in accordance with claim 11 thus characterized that the sleeve to be changed during the fitting process is always either carried by the take-up device (18) or by the roller (13, 16) or by both of the aforementioned component parts (13, 16, 16) together.

13. Process in accordance with claim 1 thus characterized that the take-up device (18) that carries the removed sleeve (12, 15), is driven out of the position favorable for the removal, after the removal of the sleeve (12, 15), and that the take-up device (18), which contains the new sleeve to be brought in to the inking unit (25, 26), is brought into this position.

14. Process in accordance with claim 1 thus characterized that a carrier bar (18) is used as a take-up device.

15. Process in accordance with claim 14 thus characterized that the position of at least the one carrier bar (18) during the take-up or the removal of a sleeve (12, 15) is changed in such a manner that the carrier bar is aligned with the axis of the printing roller and/or of the anilox roller (13,16), whose sleeve (12, 15) is to be changed.

16. Process in accordance with claim 14 thus characterized that two carrier bars (18) are simultaneously brought into a position, in which the first is aligned with the axis of the printing roller (16) and the second with the axis of the inking roller (13) of an inking unit.
